(19) United States
(12) Patent Application Publication
(10) Pub. No.: US 2012/0190253 A1
(43) Pub. Date: Jul. 26, 2012

(54) LAMP CONNECTION DEVICE

(76) Inventors: Tjong-Ren CHANG, Hsinchu City (TW); Wei-Yuan Tsou, Taoyuan County (TW); Chun-Chieh Huang, Hsinchu City (TW); Chin-Chia Chang, Keelung City (TW)

(21) Appl. No.: 13/157,749

(22) Filed: Jun. 10, 2011

(30) Foreign Application Priority Data
Jan. 20, 2011 (TW) 100102150

(51) Int. Cl. H01R 11/09

(52) U.S. Cl. 439/788

(57) ABSTRACT

A lamp connection device, which connects with an external circuit and a lamp, comprises an elastic conduction member having at least one engagement section and two winding connection members respectively formed at two ends of the elastic conduction member. The conductive wire of the external circuit and the conductive filament of the lamp are electrically connected to the elastic conduction member via the winding connection members. The engagement section is electrically connected with the conductive wire and conductive filament. Thereby, the lamp can be electrically connected with the external circuit, and the lamp connection device can be bent to flexibly connect to different lamp holders or lamp shades. The serrate structure of the engagement section also can realize invasive electrical connection to prevent increased resistance caused by the oxide layer formed on the surface of the conductive wire.

### FIELD OF THE INVENTION

The present invention relates to a connection device, particularly to a lamp connection device.

### BACKGROUND OF THE INVENTION

A lamp tube must connect with an external circuit and power source to obtain power supply to emit light. Space factor is not so important for household lamp tubes, thus a special structural design is usually unnecessary for them. As the LCD (Liquid Crystal Display) has been very popular now, the manufacturers constantly try to fabricate the LCD compact and slim as much as possible. The volume and weight of a backlight module are the primary factors influencing the thickness of the LCD.

Usually, the lamp tube of a backlight module is connected with an external circuit or a power source through solder. The conductive wire of a lamp tube is made of conductive metal, which is likely to be oxidized in the air and an oxide layer would be formed on the conductive wire. The oxide layer would impair electric conduction and should be removed with a chemical agent before soldering. The oxide layer removing process increases the fabrication cost, and the chemical agent is also dangerous. Next, the conductive wire is going to be connected with the external circuit or power source through solder, but a problem of false welding easily occurs in the soldering process. Further, since the solder is a toxic material, it is likely to generate poisonous vapor after being heated during soldering process. Therefore, a safety concern would be achieved if a solder fabrication process is eliminated.

A US publication No. 2010/0259149 discloses a “Lamp Device and Light Source Module with Coil Connecting Tube”, wherein the lamp device includes a lamp and a coil connecting tube. The lamp has one end and a conductive wire extended outward from the end. The coil connecting tube is arranged corresponding to the end of the lamp. The coil connecting tube is wound and electrically connected with the conductive wire of the lamp. The wound lamp is installed in the lamp coupling seat to electrically connect the lamp and the lamp coupling seat to improve heat dissipation effect. However, the oxide layer formed on the surface of the conductive wire still impairs electric conduction between the coil connecting tube and the conductive wire. Further, the coil connecting tube is directly connected with the lamp coupling seat, and the joint mode therebetween is inflexible. Thus, the prior art is hard to adapt to various designs of the lamps and unable to improve space application.

### SUMMARY OF THE INVENTION

The primary objective of the present invention is to provide a lamp connection device, which is exempted from a soldering process that is used to connect a lamp with an external circuit in the conventional technology.

Another objective of the present invention is to provide a lamp connection device, which can be flexibly bent to meet different component layouts.

To achieve the abovementioned objectives, the present invention proposes a lamp connection device, which connects with an external circuit and a lamp. The lamp connection device comprises an elastic conduction member having at least one engagement section, and two winding connection members respectively formed at two ends of the elastic conduction member. The elastic conduction member includes a plurality of coils formed via winding a wire. The coils have a center in an axial direction, and no gap is formed between the adjacent coils. The winding connection members are wound to form a taper structure along the axial direction of the elastic conduction member. The taper structure has a tip end facing toward the central portion of the elastic conduction member and connected to the elastic conduction member, and another end connected with the external circuit and the lamp. A conductive wire of the external circuit and a conductive filament of the lamp are connected to the elastic conduction member via the winding connection members. The engagement section is electrically connected with the conductive wire of the external circuit and the conductive filament of the lamp.

In comparison with the conventional technology, the present invention neither needs a soldering process nor uses a chemical agent to remove the oxide layer on the conductive wire. Therefore, a chemical fabrication process can be eliminated in the present invention, and also the invention is exempted from poisonous vapor generated by soldering and the problem of false welding. Further, the taper structure of the invention can flexibly connect to different sizes of conductive wires and external circuits, and can also connect to various electronic devices with different outer diameters. Furthermore, the lamp connection device of the present invention can be flexibly bent to meet different component layouts and promote space application for electronic devices.

### BRIEF DESCRIPTION OF THE DRAWINGS

FIG. 1 is an exploded view schematically showing a lamp connection device according to one embodiment of the present invention;

FIG. 2 is a schematic view showing a lamp connection device according to one embodiment of the present invention in an assembly condition;

FIG. 3 is a partially-enlarged view schematically showing a lamp connection device according to one embodiment of the present invention; and

FIG. 4 is a schematic view showing a lamp connection device according to one embodiment of the present invention in a bending condition.

### DETAILED DESCRIPTION OF THE PREFERRED EMBODIMENTS

The technical contents of the present invention are described in detail in cooperation with drawings below.

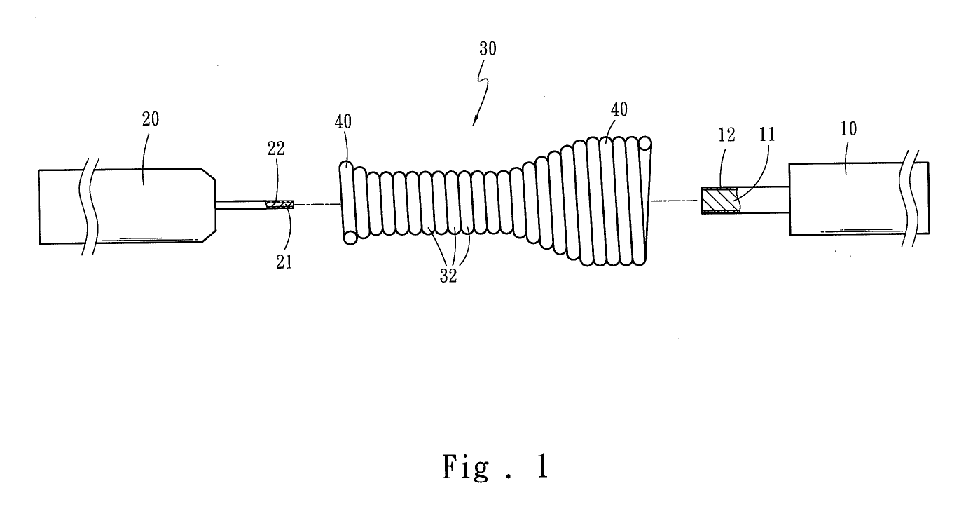

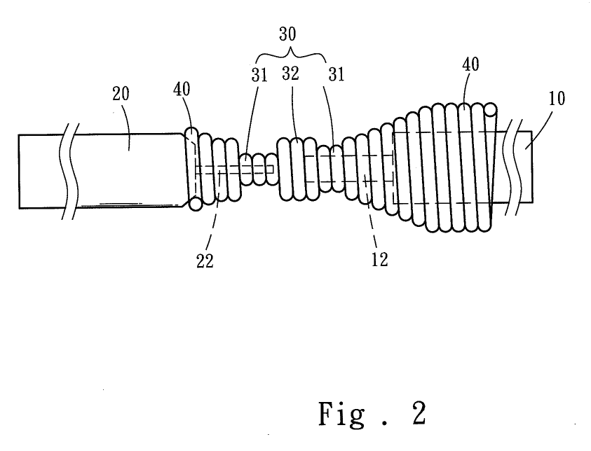

Refer to FIG. 1 and FIG. 2. The lamp connection device of present invention connects with an external circuit 10 and a lamp 20. In one embodiment, the external circuit 10 is a ballast, which is electrically connected with the lamp 20 to ignite the lamp 20. The lamp connection device comprises an elastic conduction member 30 and two winding connection members 40. The elastic conduction member 30 has at least one engagement section 31. It should be pointed out that the elastic conduction member 30 includes a plurality of coils 32 formed via winding a wire. The coils 32 have a center in an axial direction. When no external force is applied, no gap is formed between the adjacent coils 32. As shown in the drawings, the coils 32 are wound spirally layer by layer to avoid the gap existing. If there is a gap existing between two adjacent coils 32, sparks may occur and cause danger during electric conduction. Therefore, the coils 32 of the elastic conduction member 30 must be closely packed.

The two winding connection members 40 are respectively formed at two ends of the elastic conduction member 30. The winding connection members 40 are wound to form a taper structure along the axial direction of the elastic conduction member 30. The taper structure has a tip end facing toward the central portion of the elastic conduction member 30 and connected with the elastic conduction member 30, and another end connected with the external circuit 10 and the lamp 20. In one embodiment, the coils 32 of the elastic conduction member 30 are wound and extended to form the two winding connection members 40, whereby the lamp connection device is integratedly fabricated. The expanding portion of the taper structure can be adaptively connected with lamps 20 or external circuits 10, which respectively have different outer diameters. Therefore, it is unnecessary to fabricate the lamp connection device of the present invention in different specification to meet various outer diameters of the external circuits 10 or the lamps 20.

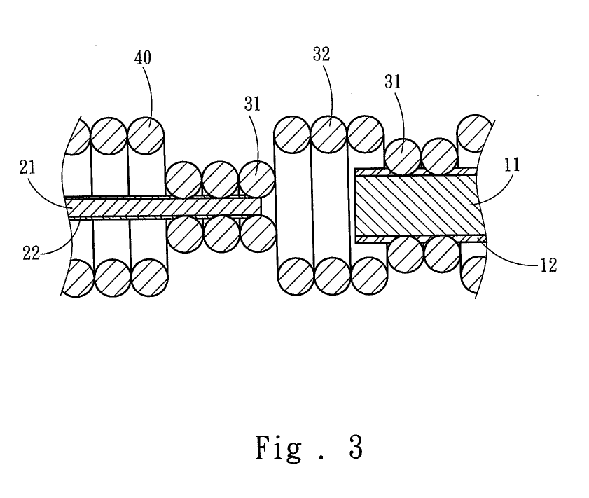

Refer to FIG. 3. The conductive filament 21 of the lamp 20 and the conductive wire 11 of the external circuit 10 respectively pass through the hollow portions of the winding connection members 40 to the elastic conduction member 30, and the engagement section 31 electrically connects to the conductive filament 21 of the lamp 20 and the conductive wire 11 of the external circuit 10. In general, the conductive wire 11 of the external circuit 10 and the conductive filament 21 of the lamp 20 respectively have an oxide layer 12 and 22 formed thereon. As the engagement section 31 is formed closely to the packed coils 32, it is formed in a serrate-like structure. Through the external force squeezing the oxide layers 12 and 22, the engagement section 31 directly connects to the conductive filament 21 of the lamp 20. In one embodiment, there are two engagement sections 31 respectively corresponding to the conductive wire 11 of the external circuit 10 and the conductive filament 21 of the lamp 20. In addition, the elastic conduction member 30 and the two winding connection members 40 are respectively made of metal. On one hand, metal has good conductivity to facilitate electric conduction; on the other hand, metal has better malleability and higher hardness to facilitate extension and deformation during compression and favor invasively passing through the oxide layers 12 and 22 and connection with the conductive filament 21 or conductive wire 11. Therefore, the lamp connection device of the present invention has superior performance in electric conduction.

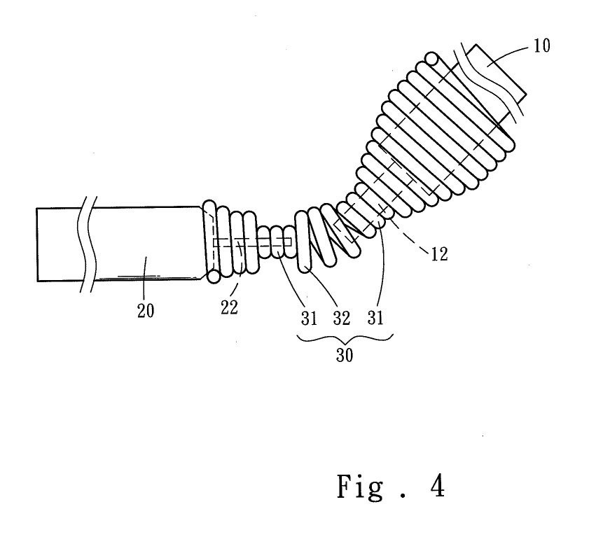

Refer to FIG. 4. The lamp connection device of the present invention can be bent to install in various layouts of the lamps and the lamp holders. Thereby is provided appropriate application and saved space occupation. Such a structure particularly favors volume reduction of the backlight module and slimness of the LCD. It should be mentioned particularly that although gaps would be formed at the expanding portion of the bent coils 32, the inner portion of the bent coils 32 still connect with each other. Current will flow along the shortest path, i.e. the inner portion of the elastic conduction member 30 without generating sparks and causing danger.

The lamp connection device of the present invention can be flexibly bent through the elastic conduction member 30. The winding connection members 40 are adaptive to different sizes of conductive wires 11 and conductive filaments 21, and the engagement section 31 can invasively connect with the conductive wires 11 and conductive filaments 21. Therefore, the present invention neither uses a soldering process nor uses a chemical agent to remove oxide layers 12 and 22 on the conductive wires 11 and conductive filaments 21. Thus, the present invention is exempted from poisonous vapor generated by soldering and the problem of false welding.

From the above description, it is known that the present invention possesses utility, novelty and non-obviousness and meets the condition for a patent. Thus, the Inventor files the application for a patent. It will be appreciated if the patent is approved fast.

The embodiments described above are only to exemplify the present invention but not to limit the scope of the present invention. Any equivalent modification or variation according to the scope of the present invention is to be also included within the scope of the present invention.

What is claimed is:

1. A lamp connection device, which connects with an external circuit and a lamp, comprising:
an elastic conduction member including at least one engagement section and a plurality of coils formed via winding a wire, the coils including a center formed in an axial direction; and
two winding connection members respectively formed at two ends of the elastic conduction member, the winding connection members being wound to form a taper structure along the axial direction of the elastic conduction member; the taper structure including a tip end facing toward a central portion of the elastic conduction member and connected with the elastic conduction member, and another end connected with the external circuit and the lamp;
wherein the external circuit and the lamp are respectively have a conductive wire and a conductive filament, which are electrically connected to the elastic conduction member via the winding connection members; and
wherein the engagement section is electrically connected with the conductive wire of the external circuit and the conductive filament of the lamp.

2. The lamp connection device according to claim 1, wherein the coils of the elastic conduction member are extended and wound to form the two winding connection members.

3. The lamp connection device according to claim 1, wherein the elastic conduction member is made of metal.

4. The lamp connection device according to claim 1, wherein the conductive filament of the lamp includes an oxide layer on the surface thereof, the engagement section being compressed to squeeze the oxide layer through an external force to directly connect with the conductive filament of the lamp.

5. The lamp connection device according to claim 1, wherein the conductive wire of the external circuit includes an oxide layer on the surface thereof, the engagement section being compressed to squeeze the oxide layer through an external force to directly connect with the conductive wire of the external circuit.
